(19) United States
(12) Patent Application Publication
(10) Pub. No.: US 2012/0210398 A1
(43) Pub. Date: Aug. 16, 2012

(54) Enhanced Backup and Retention Management

(75) Inventors: Anastasios Triantafillos, Addison, IL (US); Ankur Kumar, Hyderabad (IN)

(73) Assignee: Bank of America Corporation, Charlotte, NC (US)

(21) Appl. No.: 13/026,723

(22) Filed: Feb. 14, 2011

(51) Int. Cl. G06F 21/00

(52) U.S. Cl. 726/4

(57) ABSTRACT

An enhanced backup and retention management module associated with an entity may track access and changes made to configuration files that specify backup and/or retention policies for servers located on a network. The management module may also prevent unauthorized users from accessing or making changes to the configuration files. Additional features of the system may include a reporting capability that alerts appropriate personnel of who accessed and/or attempted to modify a backup/retention policy for a server, the name of the server whose policy may have been affected, and specific details of the file modifications that were made/attempted.

### TECHNICAL FIELD

Aspects of the invention generally relate to enhanced backup and retention management capabilities. In particular, various aspects of the invention include a framework for managing backup and retention policies on a network.

### BACKGROUND

Currently, entities such as companies, departments within companies, and/or universities struggle with the fact that there are disparate backup and retention policies for servers. In general, backup and retention policies provide information on which files or file systems should be backed up and the length of time those backups are held or retained in order to support reconstructions of a network, server, etc. in case of failure.

Backup and retention policies are generally set by configuration files that map server names with the appropriate backup and retention policies. For instance, an example backup policy may specify that a particular client server should be backed up Monday through Friday from 2:00 pm to 3:00 pm. Similarly, an example retention policy may specify how long backup images should be kept on tape or disk (e.g., for 2 days, a month, etc.).

One of the problems with conventional backup and retention implementations is that individuals may change the backup and retention policies for client servers without proper authorization. These unauthorized individuals may work for an organization (e.g., a company), may be contractors associated with the organization, or may be completely unassociated with the organization. Oftentimes, the situation is complicated by the fact that these unauthorized individuals remain anonymous. To make configuration changes to the retention and backup policies, these individuals may access a configuration file directly or may interface with a graphical user interface associated with the configuration file. When unauthorized individuals gain access to a configuration file, clients do not obtain the backup and retention policies that they expect to be in place on their servers.

For instance, assume that the retention policy set by an authorized individual at an organization is 30 days. If another individual reconfigures the retention policy to 2 days, the organization may not have the backup files necessary for restoring the network in the event of a network failure within the last 28 days of this 30 day policy period.

Therefore, there is a need for preventing such unauthorized changes to the backup and retention policies that exist within a network.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure address one or more of the issues mentioned above by disclosing methods, computer readable media, and apparatuses for managing backup and retention policies on systems and/or files located within a network. A backup and retention management module may be used to manage backup and retention policies for information on the network.

With another aspect of the disclosure, a backup and retention management module may prevent unauthorized access and changes to backup and retention policies stored on a network. This feature may be implemented by tracking access/changes to relevant files and taking appropriate action when unauthorized access and/or changes are made to the files.

Aspects of the disclosure may be provided in a computer-readable medium having computer-executable instructions to perform one or more of the process steps described herein.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present invention is illustrated by way of example and is not limited in the accompanying figures in which like reference numerals indicate similar elements and in which:

FIG. 1 shows an illustrative operating environment in which various aspects of the disclosure may be implemented.

FIG. 2 is an illustrative block diagram of workstations and servers that may be used to implement the processes and functions of one or more aspects of the present disclosure.

FIG. 3 is an example method for implementing an enhanced backup and retention management module in accordance with one or more aspects of the disclosure.

FIG. 4a is a first example user interface or display screen associated with an enhanced backup and retention management module in accordance with one or more aspects of the disclosure.

FIG. 4b is a second example user interface or display screen associated with an enhanced backup and retention management module in accordance with one or more aspects of the disclosure.

### DETAILED DESCRIPTION

As discussed above, there are problems associated with the way backup and retention policies are currently maintained within a network associated with an entity. For instance, policies may be modified in unauthorized ways and/or by unauthorized people.

In accordance with various aspects of the disclosure, methods, computer-readable media, and apparatuses are disclosed in which an entity, such as a company, government agency, university, etc., may track changes to backup and retention policies and may prevent unauthorized changes from being made to these policies. In general, backup policies may specify a schedule for performing a backup and a name of a server associated with the backup policies. Moreover, retention policies may specify a length of time for storing a backup image associated with the server. An organization, e.g., a company, may use aspects of the disclosure to manage backup and retention policies for various servers that may be a part of the organization's network. To provide this service, an organization may use a computing device to monitor access to hardware and/or software used to implement backup and retention policies for a network. Within this structure, when an attempt at inappropriate access to a configuration file storing backup and retention policies is detected, the computing device may prevent access from being gained and may store information regarding the identity and/or source behind the unauthorized access. Furthermore, if unauthorized changes are made to one or more configuration files detailing the backup and retention policies, the computing device may override the changes and cause the most recent authorized version of the files to be restored within the network. To further enhance security, the configuration files detailing the backup and retention policies may be locked to help prevent unauthorized access. Thus, unwanted or unintended tampering with configuration files that govern backup and retention policies may be eliminated or dramatically curtailed.

In accordance with other aspects of the disclosure, an enhanced backup and retention management module (e.g., a computing device) may aid in standardizing and simplifying various backup and retention policies that are implemented within an entity. In particular, the management module may set programmable thresholds for a maximum and/or minimum number of backup and retention policies that may be authorized within a network. When the number of active retention and backup policies falls above or below these thresholds, the enhanced backup and retention management module may issue an alert that notes the violation. The management module may send the alert to a system administrator and/or system server/computing device for further analysis. The system administrator and/or system server may then investigate the alert and take appropriate action (e.g., revoke a new backup and retention policy, implement a new backup and retention policy, query the management module for more information, etc.) In other aspects, upon receiving a violation alert, the system administrator may apply corrections on a non-standard backup/retention policy and/or investigate a client requirement and map a backup/retention policy on the requirement.

The alert message (e.g., an email message, sms message, etc.) may include the name of the server within the network to which the alert corresponds, the details of the backup and retention policies affected, the identity of the person/system causing the policy violation to take place, the date/time of the policy violation, etc. In other embodiments, the enhanced backup and retention management module may send an alert message when a configuration file detailing backup and retention policies is accessed and/or when the configuration file is modified in any way. In this way, the enhanced backup and retention management module may place tighter controls on who accesses and who is authorized to make changes to backup and retention policies within a network. In other aspects, the alert messages may include an old value of the backup/retention configuration and a new value of the backup/retention configuration. If there is no new value of the backup/retention configuration, then the respective policy/retention may be deleted. If there is no old value of the backup/retention configuration reported, then a new backup/retention policy may be created.

Computer-executable instructions stored in a memory of the computing device may effectuate the implementation of this enhanced management of backup and retention policies within a network. In some embodiments, the enhanced backup and retention management module may be integrated with conventional configuration files for backup and retention. In other embodiments, the enhanced backup and retention management module may exist as a discrete system communicating remotely with conventional configuration files.

Entities such as organizations may submit backup and retention requirements to the enhanced backup and retention management module for implementation of specific backup and retention policies (e.g., in the form of a open storage request form, etc.) These requests may include a server name, the time of day and days of the week for which a backup should be made for the named server, and the number of days for retaining the most recently generated backup image, among other things.

An Internet (or Intranet) web portal may assist users in interfacing with the enhanced backup and retention policy management module. The portal may allow users to investigate alerts generated by the management module, to set backup and retention management policies, and to modify these policies.

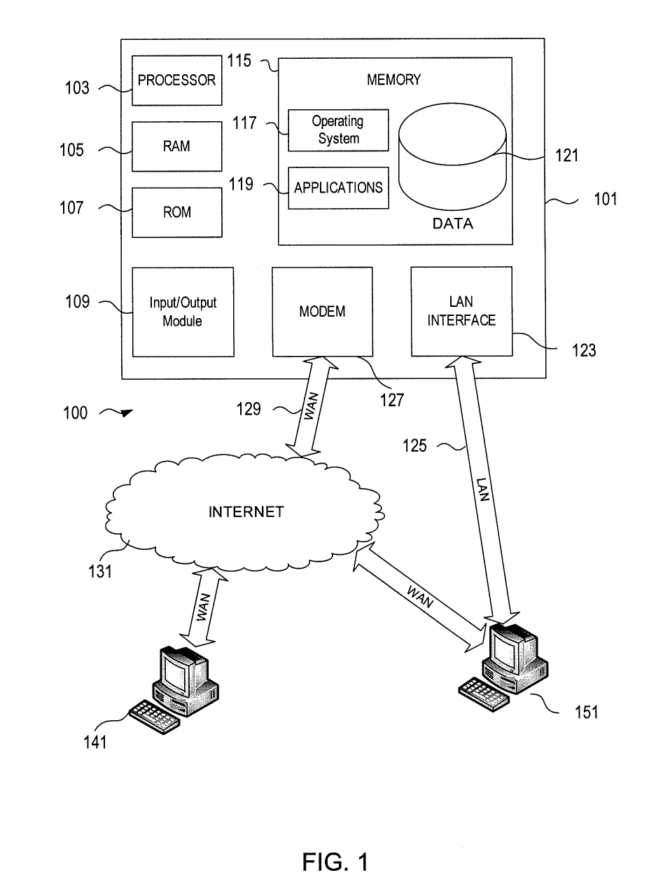

FIG. 1 illustrates a block diagram of an enhanced backup and retention management module/device 101 (e.g., a computer server) in communication system 100 that may be used according to an illustrative embodiment of the disclosure. The device 101 may have a processor 103 for controlling overall operation of the enhanced backup and retention management module 101 and its associated components, including RAM 105, ROM 107, input/output (I/O) module 109, and memory 115.

I/O 109 may include a microphone, keypad, touch screen, and/or stylus through which a user of the enhanced backup and retention management module 101 may provide input, and may also include one or more of a speaker for providing audio output and a video display device for providing textual, audiovisual and/or graphical output. Software may be stored within memory 115 and/or storage to provide instructions to processor 103 for enabling device 101 to perform various functions. For example, memory 115 may store software used by the device 101, such as an operating system 117, application programs 119, and an associated database 121. Processor 103 and its associated components may allow the device 101 to run a series of computer-readable instructions to track modifications made to backup and retention policies within a server network owned by an entity. For instance, if a user changes the retention policy of the backup image from 2 days to 10 days, processor 103 may cause module 101 to send an alert message to the appropriate system administrator. In addition, if processor 103 determines that module 101 has been inappropriately accessed, the alert message may include the identity and/or source of the inappropriate access, the components of the configuration file(s) inappropriately accessed, and the name of the sever(s) whose backup or retention policies were affected.

The server 101 may operate in a networked environment supporting connections to one or more remote computers, such as terminals 141 and 151. The terminals 141 and 151 may be personal computers or servers that include many or all of the elements described above relative to the computing device 101. Alternatively, terminal 141 and/or 151 may be a data store that is affected by the backup and retention policies stored on module 101. The network connections depicted in FIG. 1 include a local area network (LAN) 125 and a wide area network (WAN) 129, but may also include other networks. When used in a LAN networking environment, the server 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Additionally, an application program 119 used by the enhanced backup and retention management module 101 according to an illustrative embodiment of the disclosure may include computer executable instructions for invoking functionality related to tracking modifications to files containing backup and retention policies and alerting the appropriate personnel.

Enhanced backup and retention management module 101 and/or terminals 141 or 151 may also be mobile terminals, such as smart phones, personal digital assistants (PDAs), etc. including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked, for example, through a communications network. In a distributed computing environment, program modules may be located in both local and remote computer storage media including memory storage devices.

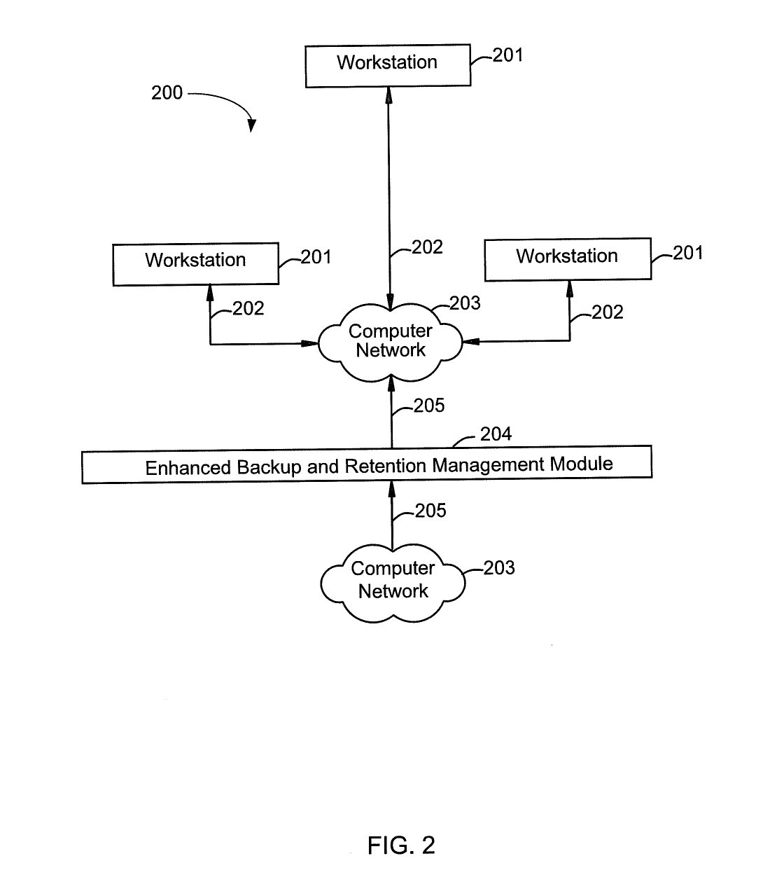

Referring to FIG. 2, an illustrative system 200 for implementing methods according to the present disclosure is shown. As illustrated, system 200 may include one or more workstations/servers 201. Workstations 201 may be local or remote, and are connected by one or more communications links 202 to computer network 203 that is linked via communications links 205 to the enhanced backup and retention management module 204. In certain embodiments, workstations 201 may be different servers that have backup and retention policies tracked by module 204, or, in other embodiments, workstations 201 may be different points at which the enhanced backup and retention management module 204 may be accessed. In system 200, the enhanced backup and retention management module 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The disclosure that follows in the Figures may be implemented by one or more of the components in FIGS. 1 and 2 and/or other components, including other computing devices.

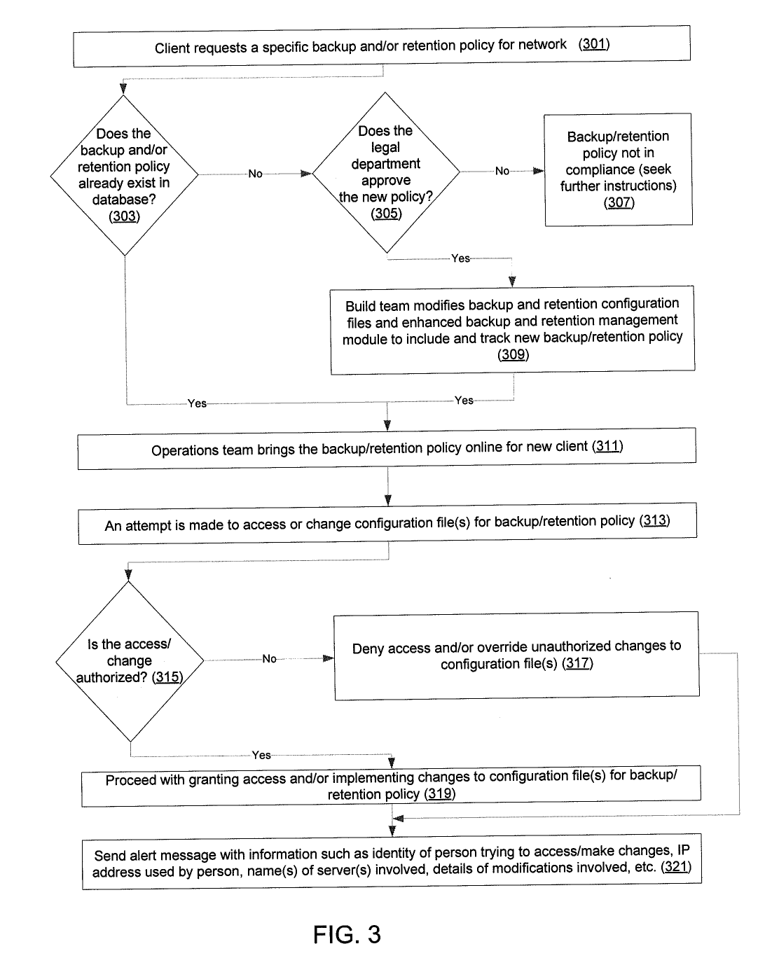

FIG. 3 shows a method for implementing an enhanced backup and retention management module in accordance with at least one aspect of the disclosure. The process may start out at step 301 where a client of an entity (e.g., an organization, company, group or department within a company, and the like) may request a specific backup and/or retention policy for servers on a network. For instance, the client may request that a portion of or all of a system, network, server, etc. be copied or backed-up on a periodic (e.g., daily, weekly, monthly, etc.) or aperiodic basis. In some examples, the client may request a backup of the desired system at a given time of day (e.g., 5:00 p.m., 1:00 a.m., etc.). The backup created of the desired system may then be held or retained for a period of time dictated by the retention policy. For instance, the backup may be held for, in some examples, 2 days, 1 week, 30 days, etc., as desired. The process may then move to decision step 303 where a decision may be made as to whether the backup and/or retention policy already exists in the entity's databases. If the requested policy does not already exist in the databases, the process may move to another decision step 305 where a decision may be made as to whether an approval team or group, such as the legal department associated with the entity, approves the requested new policy. If the legal department does not approve the policy, the requested backup/retention policy may be deemed to be noncompliant in step 307. The backup/retention policy system may then seek further instructions from appropriate personnel at the entity.

Meanwhile, if the legal department approves the new policy in step 305, the process may then move to step 309 where a department within the entity (e.g., a build team) may modify the backup and retention configuration files to include the new backup and retention policy and may update enhanced backup and retention management module 204 to include and track the new backup and retention policy.

If the backup and/or retention policy already exists in a entity's database in step 303 or after the build team updates configuration files and the enhanced backup and retention management module (e.g., 204 in FIG. 2) in step 309, the process may then move to step 311 where a department within the entity (e.g., an operations team) may bring the requested backup and/or retention policy online for the new client.

In some examples, the entity may monitor (such as via management module 204 in FIG. 2) the backup and/or retention policy for correct implementation. The management module 204 may also monitor who accesses the configuration files and who attempts to make modifications to the configuration files. When an individual attempts to access or modify the backup and/or retention configuration files for a node in the network managed by the entity in step 313, the process may move to decision step 315 where a decision may be made as to whether the access and/or attempt to modify the configuration files is authorized or unauthorized. In some aspects, the decision may be made by a system administrator after analysis of the accessed/changed backup and/or retention policy file.

If access to the configuration files and/or an attempt to modify the configuration files is not authorized, the process may then move to step 317 where access to the configuration files may be denied and/or the unauthorized changes to the configuration files may be overwritten to revert back to the most recent acceptable version. If access to and/or an attempt to modify the configuration files is authorized, the process may move to step 319 where access is granted to the configuration files and/or the modifications to the files may be implemented in the backup/retention policy. When modifications are implemented, the process may optionally return to step 303 to determine if the modified policy exists in a database or step 305 to determine if the legal department approves of the modified policy. Regardless of whether the access or modification request in step 315 is denied or granted, the process may move to step 321 where a reporting or alert message may be sent by the enhanced backup and retention management module 204 to identify the person trying to access and/or make changes to the configuration files, the IP address used by the person, names of the servers within the network involved in the access/file modification request, and details as to the nature of the file modifications made or attempted. The reporting or alert message may be sent to a system operator, department manager, operations team, or other official in charge of management of the enhanced backup and retention management module 204.

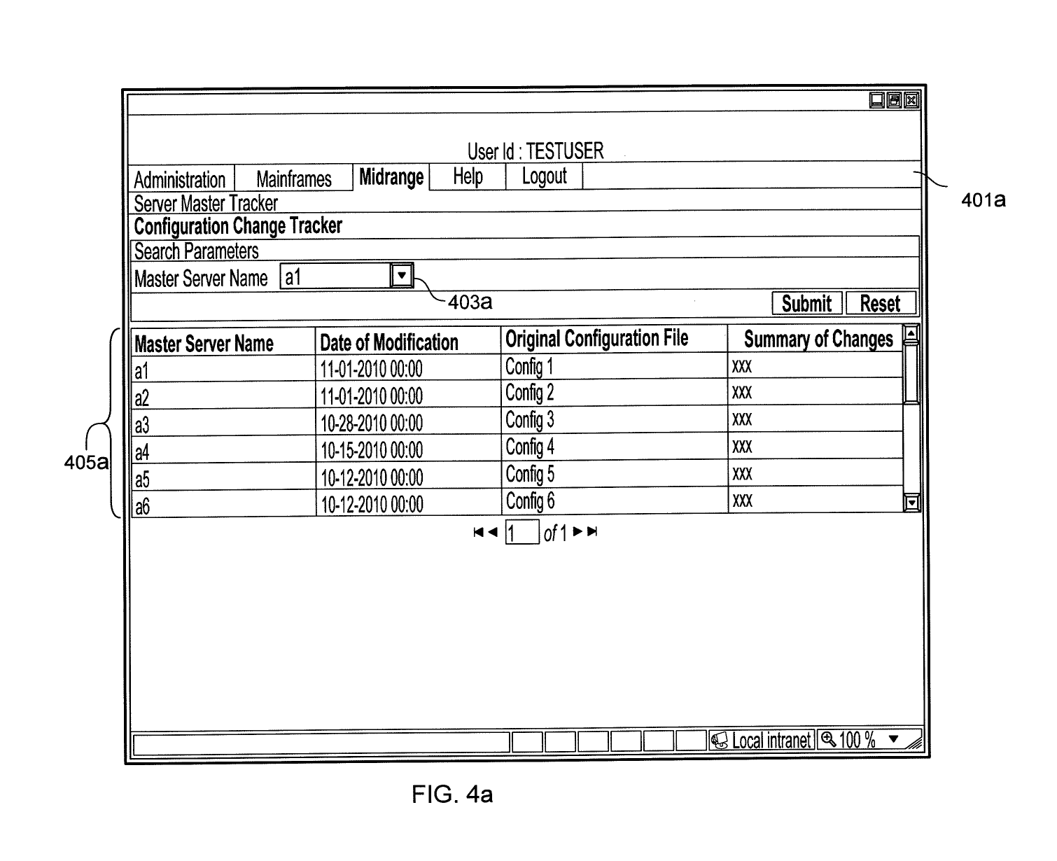

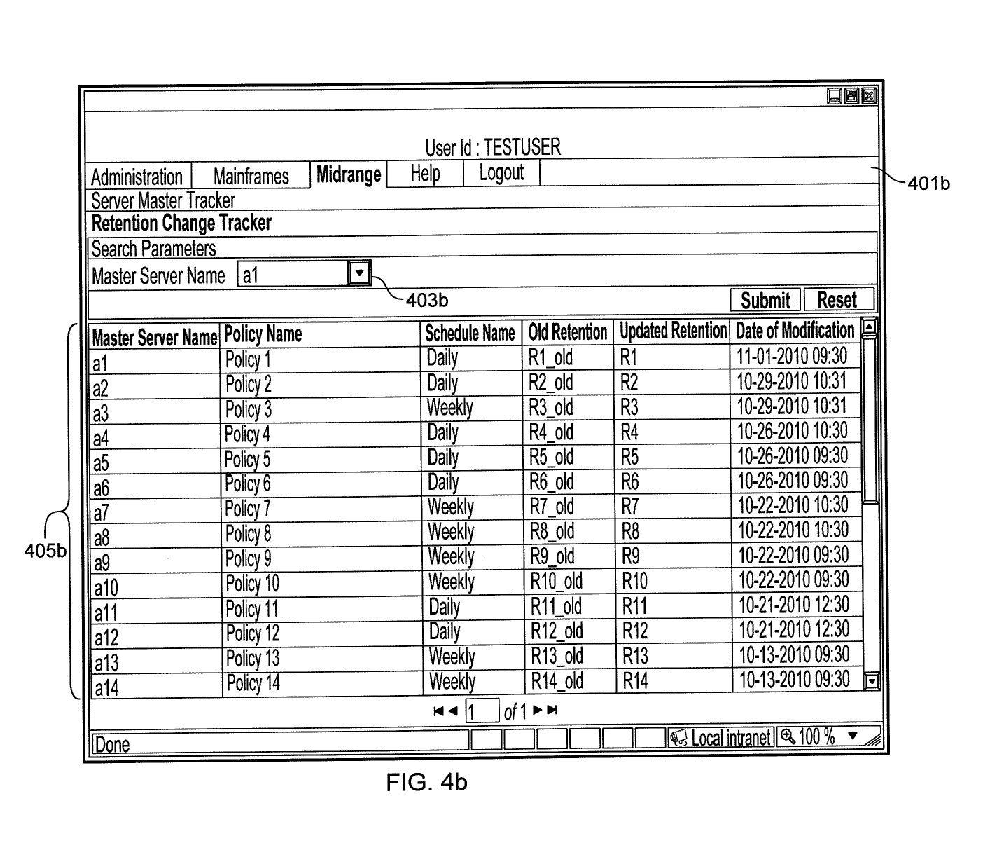

FIG. 4a is a first example user interface or display screen associated with an enhanced backup and retention management module (such as module 204 in FIG. 2) in accordance with at least one aspect of the disclosure. The display screen of FIG. 4a includes various tabs in a header section 401a, including administration, mainframes, midrange, help, and logout. Selection of the administration tab may lead to information regarding who has access to backup and retention policy configuration files and what access credentials (e.g., username, password) may be used. The mainframes and midrange tabs may allow a user to select a type of server to further investigate. The help tab may give the user more information on how to use the display interface and the information contained therein, and the logout tab may allow the user to logout of the enhanced backup and retention management module 204.

A search section 403a in FIG. 4a may allow the user to search for the server whose backup and/or retention files the user is interested in searching. Finally, an information section 405a may include a list of various server names in a particular category (e.g., associated with a network, etc., size, etc.), the date that the backup/retention files were last modified, the name of the original configuration file, and a summary of the most recent changes made to the configuration files. The display may list any number of most recent changes, including, for example, the last 10, 20, or 100 changes for each configuration file.

FIG. 4b is a second example user interface or display screen associated with an enhanced backup and retention management module 204 in accordance with at least one aspect of the disclosure. The display screen of FIG. 4b includes various tabs in a header section 401b, similar to those discussed above in FIG. 4a. FIG. 4b also includes a search section 403b, similar to the one above for FIG. 4a.

The information section 405b may include a server name, an associated retention policy name, the length of time that a backup image should be retained, the name of an old retention file, the name of an updated retention file, and the date and time that the retention file was last modified.

The above described enhanced backup and retention management module 204 may be used with various systems, including the Symantec Netbackup product and the EMC Corp. Legato product, among others. With the Symantec Netbackup product, aspects of the disclosure may be used to monitor the configuration file named bp.conf.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

What is claimed is:

1. A computer-readable storage medium having computer-executable program instructions stored thereon that when executed by a processor, cause the processor to perform steps comprising:
(i) receiving a notification of an attempt to modify at least one of a backup and retention policy by a user;
(ii) determining if the user is authorized to modify the at least one of the backup and retention policy;
(iii) if the user is authorized, accepting the modifications to the at least one of the backup and retention policy;
(iv) if the user is not authorized, preventing the user from making the modifications to the at least one of the backup and retention policy;
(v) generating a report of the attempt; and
(vi) transmitting the report to an administrator.

2. The computer-readable storage medium of claim 1, wherein the report includes an identity of the user, an IP address associated with the user, a server name affected by the modifications to the at least one of the backup and retention policy, and details of the modifications to the at least one of the backup and retention policy.

3. The computer-readable storage medium of claim 1, wherein the at least one of the backup and retention policy is detailed in a configuration file for a server on a network.

4. The computer-readable storage medium of claim 3, wherein the configuration file includes backup and retention policies for a plurality of servers on the network.

5. The computer-readable storage medium of claim 3, wherein the backup policy specifies a schedule for performing a backup and a name of a server associated with the backup policy.

6. The computer-readable storage medium of claim 3, wherein the retention policy specifies a length of time for storing a backup image associated with the server.

7. The computer-readable storage medium of claim 3, wherein the configuration file stores most recent changes made to the at least one of the backup and retention policy associated with the server.

8. The computer-readable storage medium of claim 3, wherein the configuration file stores a time and date that the at least one of the backup and retention policy was last updated.

9. The computer-readable storage medium of claim 1, wherein the report is sent as an email message.

10. A method comprising:
(i) receiving, from a processor of an enhanced backup and retention management system, a notification of an attempt to access a configuration file including a retention policy associated with a server located in a network comprising a plurality of servers;
(ii) using the processor, determining if access to the configuration file is authorized;
(iii) if authorized, using the processor, granting access to the configuration file and allowing modifications to be made to the configuration file;
(iv) if unauthorized, using the processor, denying access to the configuration file; and
(v) transmitting a message, using a communication subsystem of the enhanced backup and retention management system, to a predetermined administrator, wherein the message details a summary of the attempt.

11. The method of claim 10, wherein the configuration file further includes a backup policy associated with the server.

12. The method of claim 11, wherein the configuration file further includes backup and retention policies for a plurality of servers on the network.

13. The method of claim 12, wherein the configuration file further specifies a maximum and minimum number of backup and retention policies allowable on the network.

14. The method of claim 13, further comprising: using the communication subsystem, transmitting an alert when a total number of backup and retention policies active on the network fall outside of the maximum and the minimum number of backup and retention policies allowable.

15. The method of claim 10, wherein the notification further includes a notification of an attempt to modify the configuration file.

16. The method of claim 15, further comprising: determining if the modifications are authorized.

17. An apparatus comprising:
a processor; and
a memory configured to store computer-readable instructions that, when executed by the processor, cause the processor to perform a method comprising:
tracking an attempt to access and modify a configuration file detailing at least one of a backup and retention policy for a server located on a network;
granting access to the configuration file when a user attempting to access and modify the configuration file is authorized to access the configuration file;
allowing changes to be made to the configuration file when the user is authorized to modify the configuration file; and
transmitting a message that details the attempt to a plurality of predetermined individuals.

18. The apparatus of claim 17, wherein the message further includes an identity of an individual associated with the attempt.

19. The apparatus of claim 17, wherein the configuration file further includes backup and retention policies for a plurality of servers on the network.

20. The apparatus of claim 19, wherein the configuration file further specifies a maximum number of allowable active backup and retention policies on the network.
